(19) United States
(12) Patent Application Publication
(10) Pub. No.: US 2016/0179070 A1
(43) Pub. Date: Jun. 23, 2016

(54) ELECTRONIC DEVICE FOR CONTROLLING ANOTHER ELECTRONIC DEVICE AND CONTROL METHOD THEREOF

(71) Applicant: Samsung Electronics Co., Ltd., Gyeonggi-do (KR)

(72) Inventors: Min-Kyung HWANG, Seoul (KR); Geon-Soo KIM, Gyeonggi-do (KR); Dong-Hyun YEOM, Gyeonggi-do (KR); Yong-Joon JEON, Gyeonggi-do (KR)

(21) Appl. No.: 14/976,049

(22) Filed: Dec. 21, 2015

(30) Foreign Application Priority Data
Dec. 19, 2014 (KR) 10-2014-0184597

(51) Int. Cl. G05B 15/02; G06F 3/16; G06F 3/01; G06T 7/00

(52) U.S. Cl. CPC G05B 15/02; G06T 7/0081; G06F 3/167; G06F 3/017; G06T 2207/10004

(57) ABSTRACT

Disclosed is a control method of a management device managing a network. The control method includes detecting a first user input and transferring a first event execution command corresponding to the first user input to a first electronic device on the basis of correlation information between an event execution command from a second device and a user input, wherein each event execution command is configured to make the first electronic device execute corresponding event.

### PRIORITY

This application claims priority under 35 U.S.C. §119(a) to Korean Application Serial No. 10-2014-0184597, which was filed in the Korean Intellectual Property Office on Dec. 19, 2014, the entire content of which is incorporated herein by reference.

### BACKGROUND

1. Field of the Disclosure

The present disclosure relates generally to an electronic device and method for controlling another electronic device and, more specifically, to an electronic device and method for controlling another electronic device that outputs an event to output the corresponding event.

2. Description of the Related Art

In recent years, cloud computing technology has been actively developed. Cloud computing generally refers to next-generation computing technology which provides a service structure for an information technology (IT) environment. Among other things, cloud computing may provide a server, a storage, an Infrastructure as a Service (IaaS) for servicing a software infrastructure, a Platform as a Service (PaaS) for providing a foundation for developing software, and Software as a Service (SaaS) in which users directly use software provided through the Internet. More recently, small scale cloud concepts, such as personal cloud, hybrid cloud, and the like, have also appeared.

A cloud system may include a server to control and manage information on any electronic device connected thereto. In addition, the server may also transmit data to any connected electronic device, as well as relay data transmission/reception between multiple electronic devices connected thereto. For example, it is possible to provide a service such as turning on a TV registered in the cloud system by manipulating a wearable electronic device that is also registered in the cloud system.

In a cloud system where one electronic device controls another electronic device, the electronic device controlling the other electronic device may be referred to as the “control electronic device”, “control device”, and the like, while the controlled electronic device may be referred to as the “electronic device to be controlled”, “controlled device”, “controllable electronic device”, “controllable device” and the like.

However, typical cloud systems cannot control the electronic device to be controlled when the control electronic device is absent. Accordingly, there is a need for systems, methods, and apparatuses for controlling the electronic device to be controlled when the control electronic device is absent

### SUMMARY

The present disclosure addresses at least the issues described above and provides at least the advantages described below. According to various embodiments of the present disclosure, an electronic device and method for controlling another electronic device are provided.

According to various embodiments of the present disclosure, a control method of a management device managing a network includes: detecting a first user input and transferring a first event execution command corresponding to the first user input to a first electronic device on the basis of correlation information between an event execution command from a second device and a user input, wherein each of event execution command is configured to make the first electronic device execute corresponding event.

According to various embodiments of the present disclosure, a management device for managing a network includes: a storage module that stores correlation information between an event execution command, received from a second electronic device making the first electronic device execute an event, and a user input, and a processor that detects a first user input and transfers a first event execution command corresponding to the first user input to a first electronic device on the basis of the correlation information.

Various embodiments of the present disclosure provide an electronic device and a method that can control an electronic device to be controlled even when a control electronic device is absent from a cloud system.

Therefore, it is possible to provide a service in view of a connection between electronic devices in a network.

An electronic device, according to various embodiments of the present disclosure, enables a user to efficiently control an electronic device to be controlled through a learning algorithm.

### BRIEF DESCRIPTION OF THE DRAWINGS

The above and other aspects, features, and advantages of the present disclosure will be more apparent from the following detailed description taken in conjunction with the accompanying drawings, in which:

FIG. 1 is a block diagram of a system according to various embodiments of the present disclosure;

FIGS. 2A and 2B are flowcharts illustrating a control method of a management device according to various embodiments of the present disclosure;

FIG. 3A is a block diagram of a management device according to various embodiments of the present disclosure;

FIG. 3B is another block diagram of a management device according to various embodiments of the present disclosure;

FIG. 3C is a block diagram of a control electronic device according to various embodiments of the present disclosure;

FIG. 3D is a block diagram of a controllable electronic device according to various embodiments of the present disclosure;

FIG. 4 is a diagram illustrating a network registration process of a main controllable electronic device according to various embodiments of the present disclosure;

FIG. 5 is a diagram illustrating a network registration process of a sub-controllable device according to various embodiments of the present disclosure;

FIG. 6 is a flowchart illustrating a method of a management device to learn to associate user inputs with their corresponding events according to various embodiments of the present disclosure;

FIGS. 7A to 7D show examples of steps of the learning method in FIG. 6 and a control method based thereon, where the user input is in the form of gestures, according to various embodiments of the present disclosure;

FIGS. 8A to 8D show examples of steps of the learning method in FIG. 6 and a control method based thereon, where the user input is in the form of voice commands, according to various embodiments of the present disclosure;

FIG. 9 is a flowchart illustrating a learning method of a management device according to various embodiments of the present disclosure;

FIG. 10 is a flowchart illustrating a method of determining a region of interest according to various embodiments of the present disclosure;

FIG. 11 shows an example of a region of interest according to various embodiments of the present disclosure;

FIG. 12 is a flowchart illustrating a learning/control method of a management device according to various embodiments of the present disclosure;

FIGS. 13A, 13B, 14A, and 14B show examples of operations according to the learning/control method of FIG. 12 in various embodiments of the present disclosure;

FIG. 14C is an example of an electromyogram used in accordance with various embodiments of the present disclosure;

FIG. 15 is a flowchart illustrating a method of outputting data for recognition according to various embodiments of the present disclosure;

FIG. 16 shows an example of a glasses-type electronic device according to various embodiments of the present disclosure;

FIGS. 17A and 17B illustrate an example of data for recognition according to various embodiments of the present disclosure; and

FIGS. 18A and 18B illustrate an example of identifying different user inputs according to various embodiments of the present disclosure.

### DETAILED DESCRIPTION

Hereinafter, various embodiments of the present disclosure will be described with reference to the accompanying drawings. However, it should be understood that there is no intent to limit the present disclosure to the particular embodiments disclosed herein; rather, the present disclosure should be construed to cover any modifications, equivalents, and/or alternatives of embodiments of the present disclosure, as would be understood by one of ordinary skill in the art. In describing the drawings, similar reference numerals may be used to designate similar constituent elements.

As used herein, the expressions “have”, “may have”, “include”, or “may include” refer to the existence of the listed items/features (e.g., numeral, function, operation, or constituent element such as component), and do not exclude one or more additional items/features.

As used herein, the expressions “A and/or B”, “at least one of A and B”, “at least one of A or B”, “at least one of A and/or B”, “one or more of A and B”, “one or more of A or B”, or “one or more of A and/or B” include any or all possible combinations of items enumerated together. For example, the expressions “A and/or B”, “at least one of A and B”, or “at least one of A or B” include (1) at least one A, (2) at least one B, or (3) both at least one A and at least one B.

The expressions “a first”, “a second”, “the first”, or “the second” used to refer to various components in various embodiments of the present disclosure do not limit those referred-to components in any way, e.g., the terms do not signify an order and/or importance. The above expressions are used merely for the purpose of distinguishing an element from the other elements. For example, a first user device and a second user device indicate different user devices although both of them are user devices. Accordingly, a first element may be referred to as a second element, and similarly, a second element may be referred to as a first element without departing from the scope of the present disclosure.

The expressions “connected” and “coupled” may refer to any kind/type of linkage, including, but not limited to, mechanical, electrical, physical, electromagnetic (such as in wireless communication), etc. Moreover, for example, in mechanical, electrical, and/or physical connections, it should be understood that when an element is referred to as being (operatively or communicatively) “connected,” or “coupled,” to another element, it may be directly connected/coupled to the other element or another element (e.g., a third element) may be interposed between them.

The expression “configured to” used in the present disclosure may be exchanged with, for example, “suitable for”, “having the capacity to”, “designed to”, “adapted to”, “made to”, or “capable of” according to the situation. The term “configured to” may not necessarily imply “specifically designed to” perform specific functions in hardware. Alternatively, in some situations, the expression “device configured to” may mean that the device, together with other devices or components, “is able to”. For example, the phrase “processor adapted (or configured) to perform A, B, and C” may mean a dedicated processor (e.g. embedded processor) only for performing the corresponding operations or a generic-purpose processor (e.g., central processing unit (CPU) or application processor (AP)) that can perform the corresponding operations by executing one or more software programs stored in a memory device.

The terms used herein are merely for the purpose of describing particular embodiments and are not intended to limit the scope of the present disclosure. As used herein, singular forms may include plural forms as well unless the context clearly indicates otherwise. Unless defined otherwise, all terms used herein, including technical and scientific terms, have the same meaning as those commonly understood by a person of ordinary skill in the art. Terms are to be interpreted to have meanings consistent with contextual meanings in the relevant field of the art, and are not to be interpreted to have ideal or excessively formal meanings unless clearly defined as such in the present disclosure. In some cases, even if a term is defined in the present disclosure, it should not be interpreted in such a manner as to exclude embodiments of the present disclosure.

The term “electronic device” refers to any type/kind of electronic device. For example, an electronic device may be a smartphone, a tablet personal computer (PC), a mobile phone, a video phone, an electronic book (e-book) reader, a desktop PC, a laptop PC, a netbook computer, a personal digital assistant (PDA), a portable multimedia player (PMP), an MP3 player, a mobile medical appliance, a camera, and a wearable device (e.g., a head-mounted-device (HMD) such as electronic glasses, electronic clothes, an electronic bracelet, an electronic necklace, an electronic appcessory, electronic tattoos, or a smart watch).

An electronic device may be a smart home appliance. Such a smart home appliance may be, for example, a television, a Digital Video Disk (DVD) player, an audio player/system, a refrigerator, an air conditioner, a vacuum cleaner, an oven, a microwave oven, a washing machine, an air cleaner, a set-top box, a home automation control panel, a security control panel, a TV box (e.g., a Samsung HOMESYNC™, APPLE TV™, or GOOGLE TV™), a game console (e.g., an XBOX™ and PLAYSTATION™), an electronic dictionary, an electronic key, a camcorder, and an electronic photo frame.

An electronic device may be one of various medical devices, including, but not limited to, e.g., various portable medical measuring devices (a blood glucose monitoring device, a heart rate monitoring device, a blood pressure measuring device, a body temperature measuring device, etc.) and various medical imaging devices, e.g., a Magnetic Resonance Angiography (MRA) machine, a Magnetic Resonance Imaging (MRI) machine, a Computed Tomography (CT) machine, and an ultrasonic machine.

An electronic device may be a navigation and/or navigation-related device, including, but limited to, a Global Positioning System (GPS) receiver, an Event Data Recorder (EDR), a Flight Data Recorder (FDR), a Vehicle Infotainment Device, an electronic devices for a ship (e.g., a navigation device for a ship, and a gyro-compass), and avionic devices.

An electronic device may be, but is not limited to, security devices, an automotive head unit, a robot for home or industry, an automatic teller's machine (ATM) in banks, point of sales (POS) in a shop, or any smart device/Internet of Things (IoT) device (e.g., a light bulb, various sensors, electric or gas meter, a sprinkler device, a fire alarm, a thermostat, a streetlamp, a toaster, a sporting goods, a hot water tank, a heater, a boiler, etc.).

An electronic device may be, but is not limited to, one of a part of furniture or a building/structure, an electronic board, an electronic signature receiving device, a projector, and various kinds of measuring instruments (e.g., a water meter, an electric meter, a gas meter, and a radio wave meter).

An electronic device herein may also be a combination of two or more of the aforementioned various devices. An electronic device herein may be a flexible device. Further, an electronic device herein is not limited to the devices mentioned herein, and also includes, for example, any electronic device based on technology developed after the present disclosure.

Various embodiments of the present disclosure provide an electronic device and a method that can control an electronic device to be controlled, even when the control electronic device is absent.

According to various embodiments of the present disclosure, a management device learns the correlations between user inputs to a control electronic device and the resulting events (“correlation information”), and, when the control electronic device is absent, the management device is able to monitor for the same user inputs and perform the corresponding event when a user input is recognized. According to various embodiments of the present disclosure, the management device is adaptive, e.g., it keeps learning and can change the correlation information to match changes in the user's manner of controlling electronic devices.

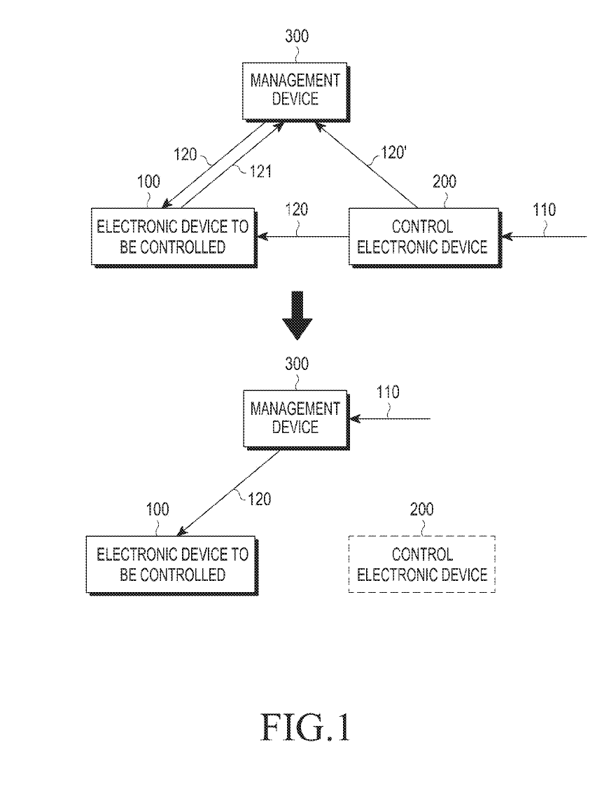

FIG. 1 is a block diagram of a system according to various embodiments of the present disclosure. The system in FIG. 1 includes electronic device 100 to be controlled, control electronic device 200, and management device 300.

The electronic device 100 to be controlled executes events, which may be set by a program or an application stored in the electronic device 100 to be controlled. For example, if the electronic device 100 to be controlled is a TV, a power management application stored in the TV may set the power-on of the electronic device 100 to be controlled as an event. Many events will have corresponding event execution commands in order to initiate and/or cause the event. Accordingly, when the electronic device 100 to be controlled receives a specific event execution command, it performs the specific event.

As shown in FIG. 1, electronic device 100 to be controlled may receive event execution commands along different paths. The electronic device 100 to be controlled may receive the event execution command 120 from the control electronic device 200, from the management device 300, and/or relayed from the control electronic device 200 through the management device 300.

As mentioned above, the terms “control electronic device” and “control device” may be used interchangeably herein, as well as the terms “electronic device to be controlled” and “controllable device”.

The control device 200 may receive user input 110 comprising a command to execute an event from the user. The control device 200 may directly transmit the corresponding event execution command 120 to the controllable device 100. For example, if the control device 200 is a watch-type electronic device, the user input 110 may be a touch gesture on a particular portion of the watch-type electronic device. The control electronic device 200 transmits event execution command 120 to the controllable device 100 on the basis of the user input 110, such as a touch gesture. Alternatively, the control device 200 may transmit an event execution command 120′ to the management device 300, which transmits/relays the received event execution command 120′ to the controllable device 100.

In an embodiment, the event execution command 120′ which the control device 200 transmits to the management device 300 may be the same as the event execution command 120 which the control device 200 transmits directly to the controllable device 100.

In another embodiment, the event execution command 120′ which the control device 200 transmits to the management device 300 may be different from the event execution command 120 which the control electronic device 200 transmits directly to the controllable device 100. In this case, the management device 300 may store information connecting the event execution command 120′ received from the control device 200 and the event execution command 120 which is in the format that needs to be transmitted to the controllable device 100. Based on such information, the management device 300 converts the event execution command 120′ from the control device 200 into the event execution command 120 which is in the format used in the controllable device 100, and transmits the converted event execution command 120 to the controllable device 100.

In the above description, which corresponds to the top part of FIG. 1, the user enters the user input 110 into the control device 200 in order to control the controllable device 100.

However, as illustrated in the bottom part of FIG. 1, the control device 200 may be absent from a network. According to the various embodiments of the present disclosure, the user may still enter the user input 110 even when the control device 200 is absent. For example, the user may perform a touch gesture (i.e., user input 110) directly on his/her body part, such as an arm, when the control electronic device 200 is absent.

The management device 300 detects user input 110 when the control device 200 is absent. For example, the management device 300 may monitor the user through a video input, such as a camera, and may detect, from a captured image or images, that the user has made the touch gesture comprising user input 110. The camera module that can photograph the user may be a part of, or directly connected to, the management device 300, according to various embodiments of the present disclosure, or the management device 300 may receive an image(s) from another electronic device including a camera module.

If management device 300 detects user input 110 when the control device 200 is absent, management device 300 transmits the event execution command 120 corresponding to user input 110 to the controllable device 100. To do so, the management device 300 stores correlation information correlating user input 110 and its corresponding event execution command 120. The stored correlation information may also (or instead) associate the event execution command 120′ received from the control device 200 with the detected user input 110. In some embodiments, the controllable device 100 may directly transmit, to the management device 300, event related information 121 that the electronic device 100 has executed a corresponding event. In such embodiments, management device 300 may use the received event related information 121 to correlate detected user input 110 with its corresponding event.

Thus, as described above, management device 300 detects the occurrence of user input 110, determines the event execution command 120 corresponding to the detected user input 110 using previously-stored correlation information, and transmits the determined event execution command 120 to the controllable device 100. The controllable device 100 then executes the event on the basis of the received event execution command 120. Accordingly, even though the user is not wearing the control electronic device 200 such as a watch-type electronic device, the user still inputs a touch gesture on his/her arm or in the air, and the management device 300 recognizes the touch gesture on the basis of the stored correlation information and transmits the event execution command to the controllable device 100.

The management device 300 may be a device for managing a network, for example, a server. In another embodiment, the management device 300 may be included in the controllable device 100. In such an embodiment, components within the controllable device 100 may detect the generation of the user input 100 and execute the first event associated with the user input 100 in response to that.

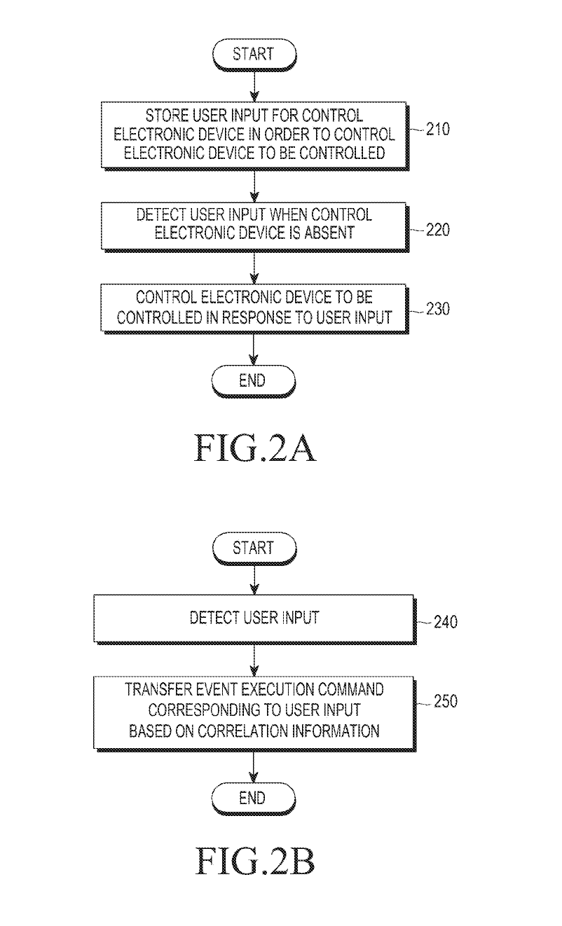

FIG. 2A is a flowchart illustrating a control method of the management device, according to various embodiments of the present disclosure.

In step 210, the management device 300 stores a user input to the control device 200 for controlling the controllable device 100. Here, the user input may be a user's gesture, speech/voice, gaze/facial expression, or the like, and anything that can be input from the user may be used herein as the user input without limitation in the type thereof.

In step 220, the management device 300 detects the generation of user input when the control device 200 is absent. For example, the management device 300 may monitor the user by photographing the user through a camera module and detecting whether the user has performed a recognizable gesture, on the basis of the captured image(s). Herein, “recognizable” or “previously-stored” user input is user input that has been previously stored in management device 300 and, thus, may be recognized when performed by a monitored user. As another example, the management device 300 may monitor the ambient sound through a microphone module in order to detect whether the user has made a recognizable voice command. As yet another example, the management device 300 may monitor the user by imaging and detecting whether the user has made a recognizable gaze/facial expression.

In step 230, the management device 300 controls the controllable device 100 in response to the detected user input. The management device 300 determines an event corresponding to the detected user input on the basis of the correlation information. The management device 300 controls the controllable device 100 to execute the event. For example, the management device 300 may transmit an event execution command to the controllable device 100. Alternatively, in embodiments where the management device 300 is included in the controllable device 100, the management device 300 may execute the event and/or control the execution of the event.

FIG. 2B is a flowchart illustrating a control method of the management device 300, according to various embodiments of the present disclosure.

In step 240, the management device 300 detects a user input by monitoring the user.

In step 250, management device 300 determines the event execution command corresponding to the detected user input based on the correlation information, and transfers the event execution command corresponding to the detected user input to the controllable device 100. Here, the correlation information may be information on the correlation between an event execution command to make the controllable device 100 execute an event and the user input for the control electronic device 200. The management device 300 may determine the first event execution command corresponding to the first user input on the basis of the correlation information. The management device 300 may transmit the first event execution command to controllable device 100. The controllable device 100 then executes the corresponding event in response to the received event execution command.

As discussed above, in another embodiment, the management device 300 may also store correlation information between the event execution command 120′ from the control device 200 and the event execution command 120 used to control the controllable device 100, so that the corresponding user input is associated with the event execution command 120 used in the controllable device 100. Accordingly, in response to the detected first user input, the management device 300 may transmit, to the controllable device 100, the event execution command which is in a format used in the controllable device 100.

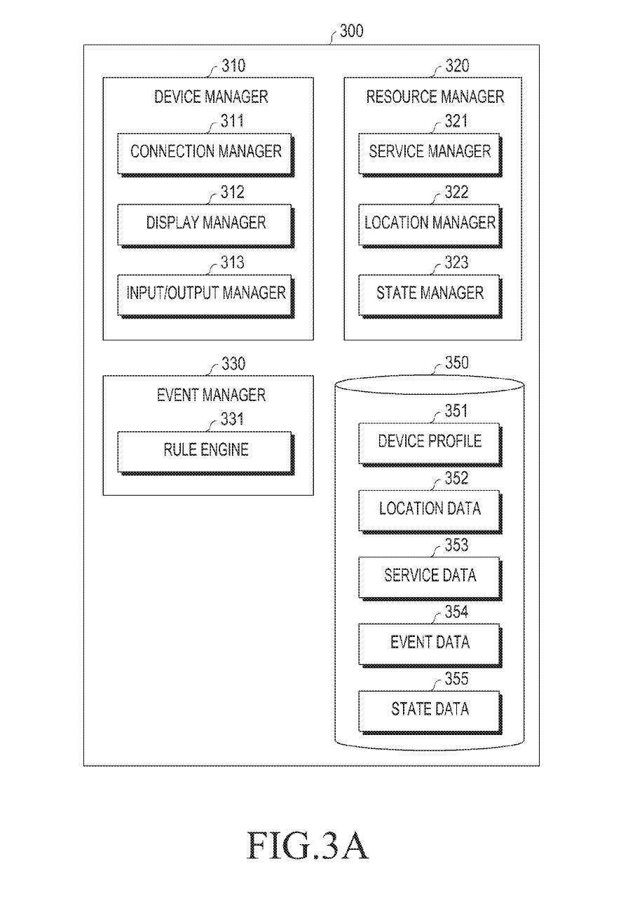

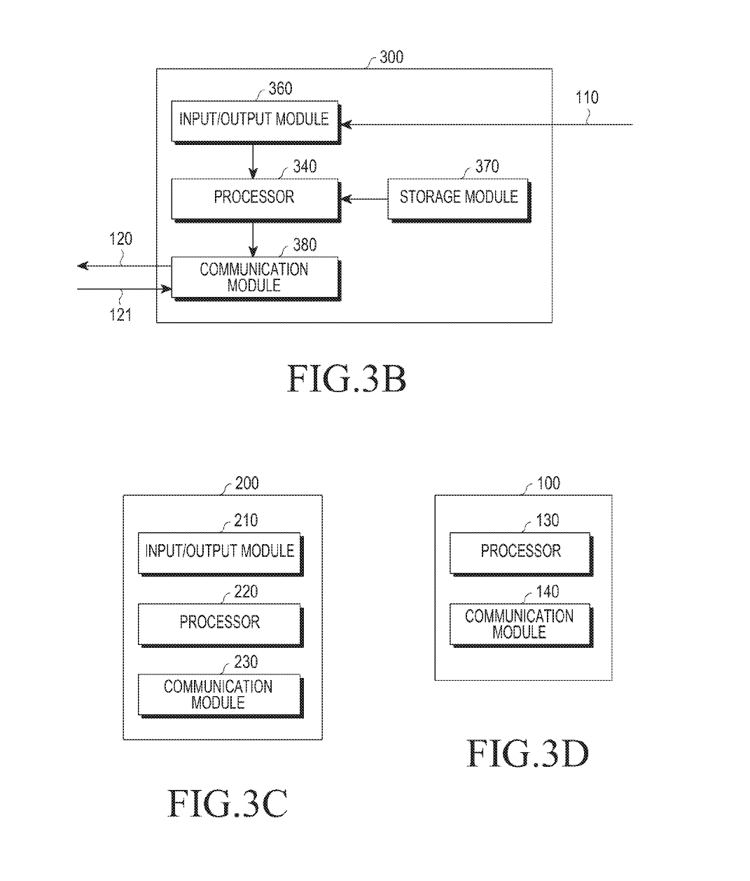

FIG. 3A is a block diagram of a management device according to various embodiments of the present disclosure.

The management device 300 in FIG. 3A includes a device manager 310, a resource manager 320, an event manager 330, and a database 350.

The device manager 310 includes a connection manger 311, a display manager 312, and an input/output manager 313. The connection manager 311 manages connection information of the control device 200 and the controllable device 100 which are connected to the management device, and performs connections with the connected devices. The display manager 312 manages display information for control of the devices and transfer the display information to the devices. The input/output manager 313 monitors input and output signals generated in the devices, and stores and manages information corresponding to those signals.

The resource manager 320 includes a service manager 321, a location manager 322, and a state manager 323. The service manager 321 manages services that the respective devices may provide, and provides information relating to the services. The location manager 322 monitors location information of the devices and provides the location information of the devices. The state manager 323 monitors state information of the devices and provides the state information of the devices.

The event manager 330 includes a rule engine 331. The rule engine 331 transfers an event execution command to the devices and controls the devices to perform an operation according to a rule. According to various embodiments, the rule may be defined in advance or generated as a result of learning.

Any one or more of the device manager 310, the resource manager 320, and the event manager 330 described above may be implemented/included in one or more processors, such as, for example, processor 340 of FIG. 3B to be described below in more detail.

The database 350 includes a device profile 351, location data 352, service data 353, event data 354, and state data 355.

The device profile(s) 351 describes device information of electronic devices constituting a network. The device profile(s) 351 may be managed in a table form, in which some data of the table may be constant, and other data may be variable. The management device 300 operates on the basis of the information in device profile(s) 351 when executing an event, and may update the device profile(s) 351 in response to an event's execution. Table 1 below has examples of the type of information stored in device profile(s) 351.

TABLE 1
Types of Information in Device Profile(s) 351

| Type | | |
|---|---|---|
| of device information | Contents | Example(s) |
| Identifier | Serial number of electronic device | 12345678 |
| | managed in database, for example, UID | |
| Type | Type of electronic device | Phone, Tablet, |
| | | Wearable device, |
| | | PC, TV, Camera |
| Model name | Brand name for electronic device model | Galaxy S5 |
| Device address | Unique identification information | MAC address |
| | included in electronic device | |
| Date information | Registration date and time for electronic | 2014-08-03 17:03 |
| | device | |
| Information as | Registration or not in intermediate | YES, NO, 1234567 |
| to whether | management electronic device for device | |
| electronic | registration: | |
| device is main | YES when registered in intermediate | |
| electronic | management electronic device, | |
| device | NO when directly registered in cloud, and | |
| | Identifier in the case of telephone | |
| Phone number | Phone number if phone number exists; | +821012345678 |
| | Phone number or Address of main | |
| | electronic device if phone number does | |
| | not exists. | |
| Device list | In the case of main electronic device, it | YES, 0000, 1234 |
| | means a list of sub-electronic devices | |
| | registered through corresponding main | |
| | electronic device. | |
| | YES in the case of main electronic device. | |
| Storage | Storage capacity | 2 gigabyte |
| capacity | | |
| Mobility | Mobility | High, Intermediate, |
| information | | Low |
| Whether | Whether display is included. Size and | 1024 × 768 |
| display is | resolution when display is included. | |
| included | | |
| Function list | List of functions that electronic device can | Call, Camera, |
| | provide. Multiple functions are | Internet, Video |
| | possible. | player, E-mail |
| Interface type | Type of supportable interface | Wifi, BLE, BT, |
| | | USB, HDMI |
| Location | Location of electronic device | Main room, Living |
| identifier | | room |
| Owner | Identifier of manager or owner of | Father |
| identification | corresponding electronic device | |
| information | | |
| Security level | Security level | High, Intermediate, |
| | | Low |
| Current state | It represents operation of electronic | On, Off, Sleep, Idle, |
| | device. | Active |
| Power | It indicates power cable, battery, and the | Power cable, 90% |
| information | like. The display of residual capacity is | |
| | possible. | |
| Connected | Information on currently connected | TV, Camera |
| device | electronic device | |
| Used function | Currently used function | Camera, Note, |
| | | Voice call |
| Connectable | Information on electronic device that can | Camera, Tablet |
| device | be additionally connected at present | |
| | location. Variable according to current | |
| | location | |

Location data 352 comprises data relating to one or more locations covered by the network. For example, Table 2 has examples of the types of data which may be in location data 352 according to an embodiment of the present disclosure.

TABLE 2
Types of Information in Location Data 352

| Type of | | |
|---|---|---|
| location | | |
| information | Contents | Examples |
| Location | Location information in network | Main room, Living |
| | system | room |
| Location | Shared identifier of | RO1 (Main room) |
| identifier | corresponding location | T01 (Rest room 1) |
| Device | Device identifier list included in | TV01 |
| identifier list | location | Phone 01 |
| Function list | Function list for each device, | Call, Camera |
| | which can be combined with | |
| | device table | |
| Service list | Service list, which can be | Video call (in operation) |
| | combined with service table | Watching movie (in |
| | | preparation) |

Table 3 provides examples of location entries/files/profiles which may be stored in the location data 352 according to various embodiments of the present disclosure.

TABLE 3
Example Entries/Files/Profiles in Location Data 352

| | Location | Device | |
|---|---|---|---|
| Location | identifier | identifier | Functions |
| Main room | R01 | TV1 | Video play |
| | | | Game |
| | | Phone1 | Voice call |
| | | | Video call |
| | | | Camera |
| | | Tablet01 | Memo |
| | | | Image play |
| Study | R02 | TV02 | Video play |
| | | Watch01 | Voice call |
| | | Camera03 | Image capturing |

Because, for example, different user inputs may be used for the same event/function in different rooms and/or different devices, the management device 300 may also store/set correlation information between user inputs, events, and locations.

Table 4 provides examples of types of information stored as the service data 353 according to various embodiments of the present disclosure.

TABLE 4
Types of Information in Service Data 353

| Type of | | |
|---|---|---|
| service data | Contents | Examples |
| Service name | Service that network can | Video call, Listening to |
| | provide | music, Monitoring, |
| | | Notification |
| Function list | Function list necessary for | Video call: Voice input, |
| | service | Video output, Video input, |
| | | White board |
| Device list | Service related device list | Camera, Microphone, TV |
| Possibility | Whether service can be | YES, NO |
| | provided at present | |
| State | Operating or not at present | YES, NO |

The management device 300 may recommend functions available at a particular location to the user in combination with a location table. The management device 300 may provide information on a location or corresponding device associated with a requested event according to the location table

Table 5 provides examples of types of information stored as event data 354 according to various embodiments of the present disclosure.

TABLE 5
Types of Information in Event Data 354

| Type of | | |
|---|---|---|
| event data | Contents | Examples |
| Event | Type of event that device can | Video call, Location |
| identifier | execute | movement, Device removal |
| Location | Location where event occurs | Living room, Main room |
| Device | Device in which event occurs | Phone, Watch2 |
| identifier | | |
| Owner | Owner of device in which | Family, Mother |
| | event occurs | |

The controllable device 100 may execute various events. Events executed in the electronic device may be different to each other when the electronic device is disposed in different networks.

Table 6 provides examples of types of information stored as state data 355 according to various embodiments of the present disclosure.

TABLE 6
Types of Information in State Data 355

| Type of | | |
|---|---|---|
| state data | Contents | Examples |
| Authority | Authority attribute of device | Public, Private |
| State | Current state of device | Idle, Low power, |
| | | Occupied |
| Reserved task | Whether reserved task has been set | YES, NO |
| Location | Relative location of device, which | Number (dBm) |
| | can be measured according to signal | |
| | strength of wireless communication. | |
| Performance | Performance index of device | Number |

State data 355 is used to describe the state of the electronic device, such as, for example, using a flag to indicate whether a controllable device is available. The management device 300 may identify the states of the controllable devices through the current values of flags, and assign control authority/usage/availability so as to prevent the control devices from colliding with each other. For example, the management device 300 may preferentially set an electronic device, for which the authority is public and the state is idle. By managing priority, it is prevented that a plurality of controls is applied to one electronic device to be controlled.

Table 7 provides examples of types of data stored in a user table according to various embodiments of the present disclosure.

TABLE 7
Types of Data in a User Table

| Type of | | |
|---|---|---|
| user data | Contents | Examples |
| Name | User name | Kim, Lee |
| Type | Group to which user basically | Parents, Children |
| | belongs | |
| Level | Level assigned to user | high, intermediate, low |
| Device list | List of devices for which user is a | 012345678 |
| | main user | |
| Location | Location of user | Main room, Living room |

The management device manages the electronic devices in the network on the basis of, inter alfa, the user table. According to the user table, authority for the use of an electronic device may vary for each user. In addition, since the user may move, location information may be included as a type of user data. Meanwhile, in cases where a TV, one electronic device to be controlled, exists in a network, the management device 300 may control the electronic device to be controlled according to authority for each user.

FIG. 3B is another block diagram of a management device according to various embodiments of the present disclosure. FIGS. 3A and 3B may be considered two different views of the functional components in the same management device 300. As explained above, device manager 310 (or parts thereof), resource manager 320 (or parts thereof), and/or event manager 330 (or parts thereof) in FIG. 3A may be at least partially implemented by processor 340 in FIG. 3B. Similarly, database 350 in FIG. 3A may be at least partially implemented by storage module 370 in FIG. 3B.

Management device 300 in FIG. 3B includes a processor 340, an input/output module 360, a storage module 370, and a communication module 380.

The input/output module 360 detects, captures, and/or otherwise acquires user input. In embodiments where the user input 110 is a gesture or gaze/facial expression, the input/output module 360 may be implemented by a camera module. Such an input/output module 360 may monitor a user by photographing/imaging the user in order to recognize any user input, such as, for example, a recognizable gesture or gaze/facial expression. An input/output module 360 implemented as a camera module for capturing a still image or a moving image, may include one or more image sensors (e.g., a front sensor or a rear sensor), a lens, an Image Signal Processor (ISP), or a flash (e.g., an LED or a xenon lamp) according to the particular implementation/embodiment. According to another embodiment, the input/output module 360 is implemented by an interface in management device 300 that is connected to, and can thereby receive data from, a separate camera module including an image sensor. That is, the management device 300 may physically include the actual input device, such as a camera module, or may only be connected to the actual input device, such as another electronic device including a camera module. As mentioned earlier, the types and variety of user input are not limited, and thus input/output module 360 may receive data of all sorts of detectable input, such as input from wearable sensing modules, microphone modules, infrared sensors, ultrasonic sensors, and the like. Moreover, the processor 340 may combine a plurality of pieces and/or types of input data to detect a user input. In such an embodiment, the processor 340 may assign weight values to each of the plurality of pieces of data and use the weighted data to detect a user input.

The storage module 370 stores correlation information between, for example, user input 110, the corresponding event execution command 120, and/or the corresponding event executed in the controllable device 100. The correlation information may be stored using adaptive, i.e., one or more learning, algorithms. The storage module 370 may be, but is not limited to, any of a hard disk, a floppy disk, magnetic media (e.g., a magnetic tape), optical media (e.g., a Compact Disc Read Only Memory (CD-ROM) and a Digital Versatile Disc (DVD)), magneto-optical media (e.g., a floptical disk), a hardware device (e.g., a Read Only Memory (ROM), a Random Access Memory (RAM), a flash memory, or the like), and the like.

In cases where the control electronic device 200 is absent, the processor 340 uses input/output module 360 to detect/recognize any user input. Based on the stored correlation information, the processor 340 creates and/or retrieves (from, e.g., storage module 370) the event execution command corresponding to the detected/recognized user input, and outputs/provides the event execution command to the communication module 380. The processor 340 may be, but is not limited to, any one or more of a Central Processing Unit (CPU), an Application Processor (AP), and a Communication Processor (CP). The processor 340 may be any component which can carry out operations or data processing relating to control and/or communication of at least one other element of the management device 300. The processor 340 may be a controller or a part thereof, and/or the functions as described herein may be distributed so as to be performed by multiple processors.

The communication module 380 transmits, for example, event execution commands to controllable electronic devices. The communication module 380 may also receive event related information from controllable electronic devices which receive event execution commands directly from the control electronic device(s). In such a case, the management device 300 associates the received event related information and, for example, detected user input, and stores them all as correlation information. The communication module 130 is connected to a network through wireless or wired communication to at least communicate with any controllable or control electronic devices. The wireless communication may use a cellular communication protocol, such as, for example, at least one of Long Term Evolution (LTE), LTE Advanced (LTE-A), Code Division Multiple Access (CDMA), Wideband CDMA (WCDMA), Universal Mobile Telecommunications System (UMTS), Wireless Broadband (WiBro), and Group System for Mobile Communications (GSM). The wired communication may use any suitable format/protocol, including, for example, at least one of a Universal Serial Bus (USB), a High Definition Multimedia Interface (HDMI), Recommended Standard 232 (RS-232), and a Plain Old Telephone Service (POTS).

The network which can connect management device 300, control device 200, and/or controllable device may be, but is not limited to, a computer network, e.g., a Local Area Network (LAN) or Wide Area Network (WAN), several interconnected computer networks (such as the Internet), or part of telecommunication/telephone network. The management device 300 may be directly connected, via short range communication, to the controllable electronic device 100 and/or the control electronic device 200. Such short range communication may be implemented via, for example, Bluetooth communication, Bluetooth Low Energy (BLE) communication, Near Field Communication (NFC) communication, WiFi direct communication, infrared communication, visible light communication, ZIGBEE™ communication, and/or the like.

The processor 340 may acquire the correlation information by sources, including, but not limited to, direct/indirect input (e.g., user input, a download, a message, etc.) and experience/learning, as will be described in greater detail in reference to the accompanying drawings. Correlation information may be set according to individual users and/or groups of users. The management device 300 may also set a second user with the configured correlation information of the first user. In this case, the management device 300 may share a learning result in a group classified according to a particular criterion.

Alternatively, the processor 340 may apply a learning algorithm to the user input 110 and the first event related information received from the communication module 380 and acquire the correlation information between the user input 110 and the first event or the correlation information between the user input 110 and the first event execution command on the basis of the result of learning. Alternatively, the management device 300 may share correlation information with other users, in which case the management device 300 may change the correlation information based on the attribute (e.g., a human body attribute) of each user.

As mentioned above, the user may also set the correlation information. For example, a user may set a specific touch gesture to correspond to a specific event of a controllable device. The settings may be input, for example, via the control electronic device, which transmits the set correlation information to the management device.

According to various embodiments of the present disclosure, the storage module 370 may store the correlation information between an event execution command, received from the control electronic device 200 making the electronic device 100 to be controlled execute an event, and a user input. The processor 340 may detect a first user input and make a control to transfer a first event execution command corresponding to the first user input to the electronic device 100 to be controlled on the basis of the correlation information.

According to various embodiments of the present disclosure, the processor 340 may acquire the first user input for the control electronic device 200 when the control electronic device 200 exists in the network and associate the first user input, acquired when the control electronic device 200 exists in the network, with the first event execution command to store the correlation information in the storage module 370.

According to various embodiments of the present disclosure, the processor 340 may learn/adapt by recording/capturing, for example, the same user input performed multiple times with the control device and the revising/creating/adding/modifying the correlation information in the storage module 370 on the basis of the learning result from the multiple performances of the user input. The processor 340 may apply the learning result to other users as well.

According to various embodiments of the present disclosure, a camera module for photographing user input on/with the control electronic device may be included in the management device. By such means, for example, processor 340 may associate gesture information acquired by processing captured images of user input with its corresponding event execution command, which association is stored with the correlation information. When a similar gesture is acquired by processing captured images, the processor 340 may use the correlation information having the association to determine that the corresponding user input has been detected.

According to various embodiments of the present disclosure, the processor 340 may determine a region of interest (ROI), such as a preset body part on which the control electronic device 200 is worn, and then may acquire the ROI in captured image(s) in order to determine whether a recognizable gesture has been made in the ROI, and, if a recognizable gesture is recognized, determine that the corresponding user input has been made by the user.

According to various embodiments of the present disclosure, a microphone module included in the management device 300 may be used for recording voice commands for the control electronic device 200. The processor 340 may store such voice commands as correlation information in the storage module 370 so that processor 340 may later detect the same voice command when the control device 200 is not present.

According to various embodiments of the present disclosure, the processor 340 may associate the user input with data from the control electronic device 200 to store the correlation information in the storage module 370.

The processor 340 may control the electronic device 100 to be controlled using the data from the control electronic device 200 which is stored through the association.

The processor 340 may output data for recognition relating to the control electronic device 200.

The processor 340 may make a control to convert an event execution command in the control electronic device 200 into an event execution command in the electronic device 100 to be controlled to transfer the converted event execution command to the electronic device 100 to be controlled.

According to various embodiments of the present disclosure, the storage module 370 may store the correlation information of multiple control devices and multiple users, and processor 340 may use such correlation information to recognize user input on a new control device and/or for a new controllable device.

According to various embodiments of the present disclosure, an input/output module 360 is used to detect user input on a wearable control device for executing an event on a controllable electronic device. In addition, the input/output module 360 may be used to detect the performance of the same user input when the user is not wearing the control device. Based on this detection, processor 340 controls the controllable device to execute the corresponding event when the user is not wearing the control device.

FIG. 3C is a block diagram of the control electronic device 200 according to various embodiments of the present disclosure. The control electronic device 200 in FIG. 3C includes an input/output module 210, a processor 220, and a communication module 230.

The input/output module 210 acquires user input, which may be any one or more of various types of inputs, such as, for example, gestures, voice commands, gaze/facial expressions, and the like, from a user. It will be understood by those of ordinary skill in the art that any apparatus capable of acquiring user input may be used as the input/output module in accordance with embodiments of the present disclosure. The processor 220 controls, inter alfa, the communication module 230 to transmit event execution commands to a controllable device or to the management device in response to user input.

FIG. 3D is a block diagram of a controllable device 100 according to various embodiments of the present disclosure. The controllable electronic device 100 in FIG. 3D includes a processor 130 and a communication module 140.

The communication module 140 receives, inter alia, event execution commands from the control device 200 and/or the management device 300 (when, for example, the control device 200 is absent). The processor 130 executes the event corresponding to the received event execution command. In embodiments where the management device 300 is included/implemented in the controllable device 100, the controllable device 100 may further include an input/output module and may also detect user input.

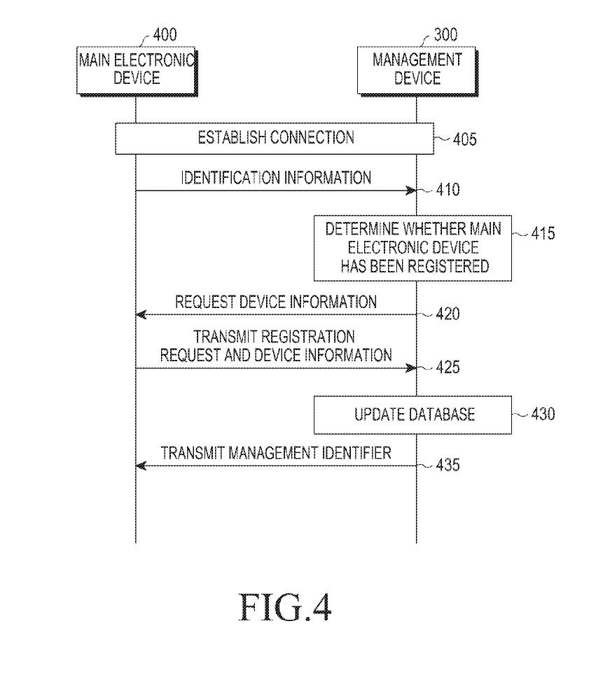

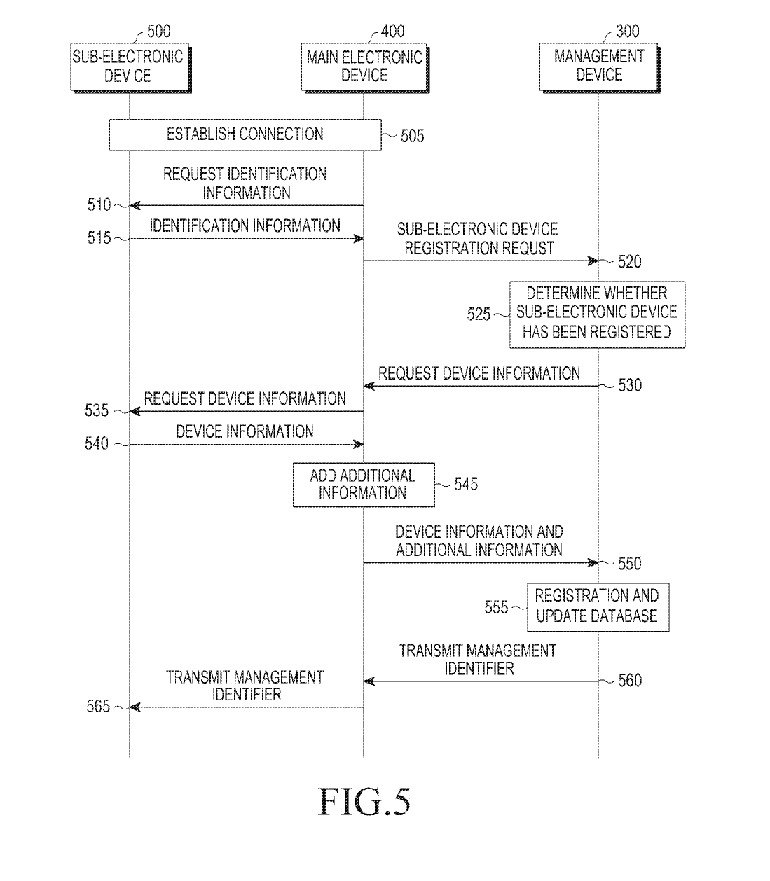

FIG. 4 is a diagram illustrating a network registration process of a main controllable device, or main electronic device, according to various embodiments of the present disclosure. In the embodiment shown in FIGS. 4 and 5, the network has a main controllable electronic device 400 which may serve as the control center, network server, and/or the like for the network, such that the other controllable devices in the network register with the main controllable device 400 (i.e., “sub-controllable devices”). Herein, the main controllable device may be referred as device which can directly connect to the control device 300. The main electronic device 400 may include a display and may also provide a graphic user interface that may acquire an input for login and a registration request.

In step 405, a connection is established between main electronic device 400 and management device 300. For example, the main electronic device 400 may establish the connection with the management device 300 using a network device.

In step 410, the main electronic device 400 transmits identification information thereof, for example, a Media Access Control (MAC) address, to the management device 300.

In step 415, management device 300 determines, based at least in part on the received identification information, whether the main electronic device 400 has already been registered in the management device 300 or with a system managed by the management device 300. The management device 300 stores device information on registered electronic devices in, for example, a database, and determines whether the main electronic device 400 is already registered by comparing the identification information received from the main electronic device 400 with the stored identification information of any registered electronic devices. In FIG. 4, it is assumed that the management device 300 determines that the main electronic device 400 has not already been registered.

In step 420, the management device 300 requests device information from the main electronic device 400. The device information is required for registration in the management device 300 or the system managed by the management device 300 and may include, but is not limited to, at least one of an identifier, a type, a model name, a device address, date information, whether the device is a main electronic device, a phone number, a device list, storage capacity, mobility information, whether the device includes a display, a function list, an interface type, a location identifier, owner identification information, a security level, a current state, power information, a connection device, a used function, and a connectable device.

In step 425, the main electronic device 400 transmits a registration request and the device information to the management device 300. In step 430, based on the received device information, the management device 300 updates its database of information for managed/registered electronic devices. The management device 300 registers the main electronic device 400 in response to receiving the registration request. The database may be implemented to have a collection of device profiles having information such as shown in, for example, Table 1 described above.

In step 435, the management device 300 transmits a management identifier for the registered main electronic device 400.

FIG. 5 is a diagram illustrating a network registration process of a sub-controllable device, or sub-electronic device, according to various embodiments of the present disclosure. As discussed above, in the embodiment of FIG. 5, other controllable electronic devices, such as sub-controllable devices, such as sub-electronic device 500, are connected to the network through a main electronic device, such as main controllable device 400.

In step 505, the sub-electronic device 500 establishes a connection with main electronic device 400. The connection may use, for example, any one of various wireless communication schemes such as Bluetooth communication, Bluetooth Low Energy (BLE) communication, NFC communication, WiFi direct communication, infrared communication, visible light communication, ZIGBEE™ communication, and the like.

In step 510, main electronic device 400 requests identification information of the sub-electronic device 500 from the sub-electronic device 500. In step 515, the sub-electronic device 500 transmits its identification information, such as, for example, a MAC address, to the main electronic device 400. In step 520, the main electronic device 400 transmits, to management device 300, a sub-electronic device registration request including the identification information of the sub-electronic device 500.

In step 525, based on the received identification information of the sub-electronic device 500, the management device 300 determines whether the sub-electronic device 500 has already been registered in the management device 300 or a system managed by the management device 300. The management device 300 may store device information on at least one registered electronic device. For example, the management device 300 may store the identification information of at least one registered electronic device. The management device 300 may determine whether the sub-electronic device 500 is a pre-registered device by comparing the identification information received from the sub-electronic device 500 with the stored identification information of all registered electronic devices. In FIG. 5, it is assumed that the management device 300 determines that the sub-electronic device 500 has not already been registered.

In step 530, the management device 300 requests device information of the sub-electronic device 500 from the main electronic device 400. As mentioned above, device information is required for registration and may include, but is not limited to, at least one of an identifier, a type, a model name, a device address, date information, whether the device is a main electronic device, a phone number, a device list, storage capacity, mobility information, whether the device includes a display, a function list, an interface type, a location identifier, owner identification information, a security level, a current state, power information, a connection device, a used function, and a connectable device.

In step 535, the main electronic device 400 requests the device information from the sub-electronic device 500. In step 540, the sub-electronic device 500 transmits the requested device information to the main electronic device 400. In step 545, main electronic device 400 adds additional information, such as a user input, e.g. information regarding sub-electronic device inputted from the user, to the device information of the sub-electronic device 500, which is then transmitted to the management device 300 in step 550.

In step 555, based on the received device and additional information added by main electronic device 400, the management device 300 updates its database for managed/registered electronic devices. In step 560, the management device 300 transmits a management identifier it generated for the sub-electronic device 500 to the main electronic device 400. In step 565, the main electronic device 400 transmits, to the sub-electronic device 500, the management identifier of the sub-electronic device 500 received from management device 300.

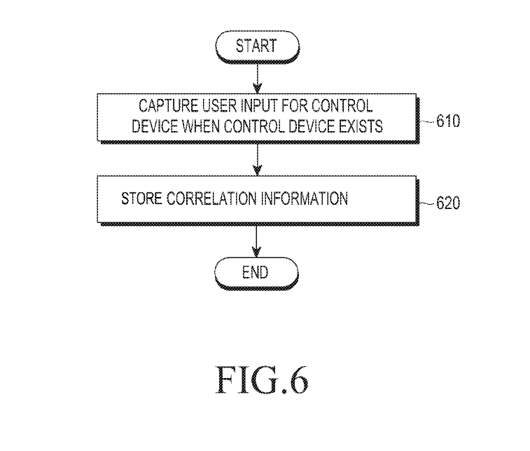

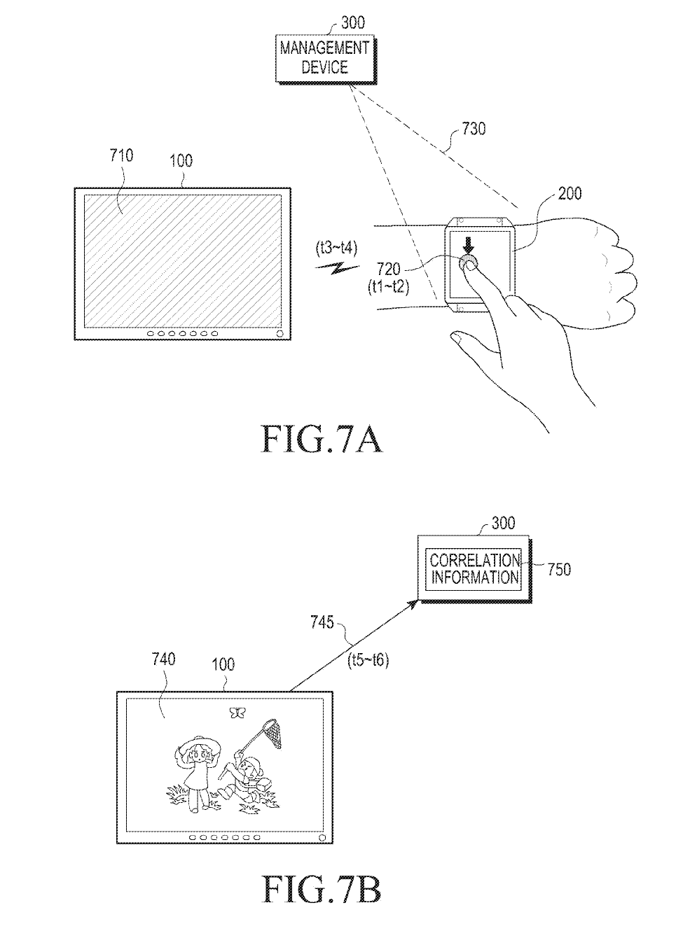

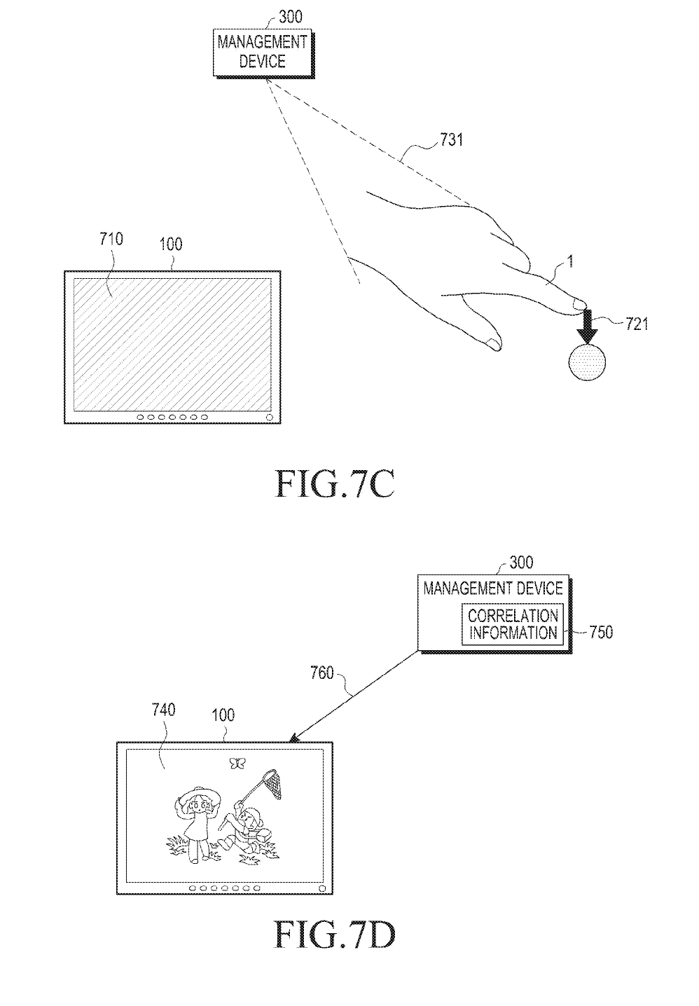

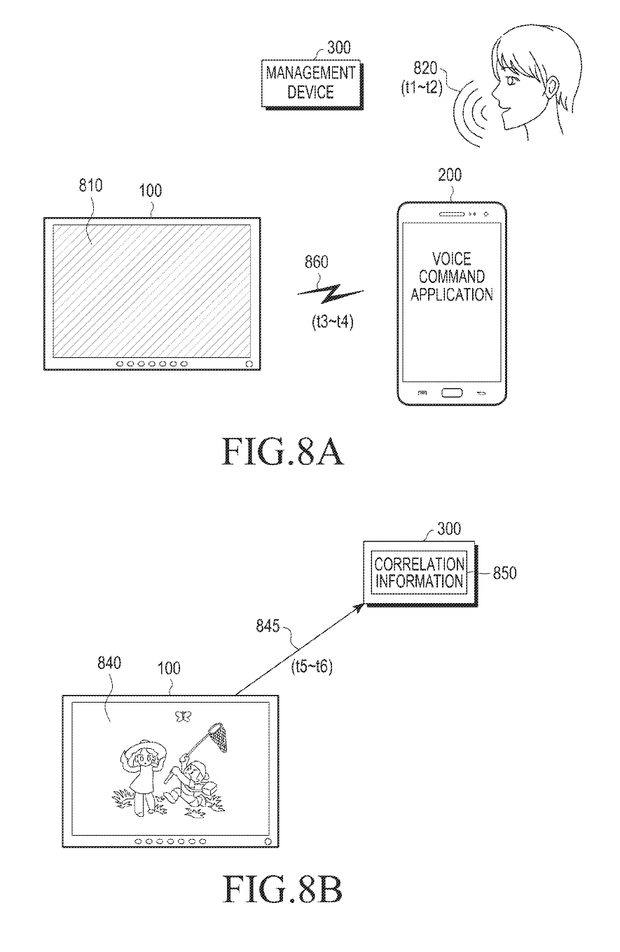

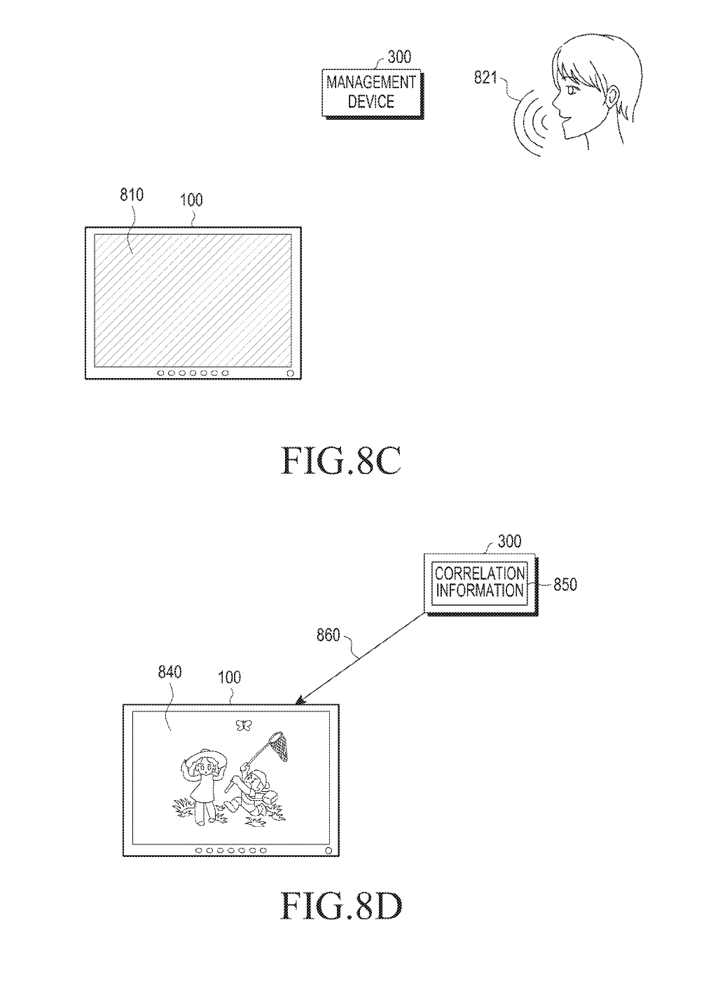

FIG. 6 is a flowchart illustrating a method of a management device to learn to associate user inputs with their corresponding events according to various embodiments of the present disclosure. FIGS. 7A-7B and 8A-8B show examples of performing the steps of the learning method in FIG. 6, according to various embodiments of the present disclosure. FIGS. 7C-7D and 8C-8D show examples of performing the steps of a control method using correlation information stored as a result of the learning in FIG. 6, according to various embodiments of the present disclosure. In FIGS. 7A to 7D, the user input is in the form of gestures, while in FIGS. 8A to 8D, the user input is in the form of voice commands.

In step 610, management device 300 captures user input to control electronic device 200.

An example of step 610 is illustrated in FIGS. 7A-7B. As shown in FIG. 7A, a user enters user input 720, comprising a gesture where a finger moves downward and then stops with a touch (indicated by a circle in FIG. 7A), into the control electronic device 200 in order to control controllable device 100. In this example, controllable device 100 starts in the off state 710, namely, in a state of being powered off, and user input 720 corresponds to the event of turning on controllable device 100. In this example, control device 200 stores and executes a control application for controlling the controllable device 100, and the control application access stored data which associates the user input 720, comprising the gesture of moving the finger downward and then making a touch on the control device 200, with a turn-on event execution command of the controllable device 100. Accordingly, when user input 720 is entered into control device 200, control device 200 transmits the turn-on event execution command to controllable device 100.

Meanwhile, the management device 300 is monitoring this activity. Specifically, management device 300 takes a photograph of the user input 720, comprising the gesture of moving the finger downward and then touching, as indicated by reference numeral 730. In this example, management device 300 includes a camera module and an input/output interface that receives images from the camera module. By these means, management device 300 may capture images of user input, by tracking the movement of the user.

However, management device 300 also has to correlate images of what may be user input with the resulting events. FIGS. 7A-7B provide one example. More specifically, management device 300 monitors and determines that the user input 720 is generated between time points t1 and t2. Afterwards, the management device 300 detects that the turn-on event execution command is transmitted from the control device 200 between time points t3 and t4. As mentioned above, depending on the particular embodiment, management device 300 may receive the turn-on event execution command directly. In some such embodiments, the management device 300 may act as a relay, i.e., transmitting the received turn-on event execution command to the controllable device 100. In embodiments where management device 300 directly monitors/receives the event execution command, management device 300 would receive the turn-on event execution command at the time control device 200 transmitted it, i.e., between time points t3 and t4.

In embodiments where management device 300 directly monitors/receives the event execution command, the management device 300 determines that the photographed user input 720 is associated with the subsequent turn-on event execution command when the difference between time points t2 and t3 is smaller than a preset threshold value.

In other embodiments, the turn-on event execution command to controllable device 100 is not received by management device 300 when control device 200 transmits it. In some such embodiments, management device 300 detects the subsequent event rather than the command. In the example illustrated in FIG. 7B, management device 300 detects the subsequent event, i.e., that the controllable device 100 is changed to the turned-on state 740 between time points t5 and t6. The manner by which management device 300 is informed of the event depends on the implementation/embodiment. For example, controllable device 100 may transmit a message 745 reporting the entrance into the turned-on state 740 to the management device 300.

Alternatively, the management device 300 may detect the execution of an event by direct monitoring. For example, management device 300 may determine that controllable device 100 enters the turned-on state 740 between time points t5 and t6 by imaging its environment. In embodiments where management device 300 directly monitors/senses events rather than commands, the management device 300 may determine that user input 720 is associated with sensed event 740 when the difference between time points t2 and t5 is smaller than a preset threshold value. The management device 300 determines the event execution command corresponding to the detected turned-on state 740 and associates that event execution command with the detected user input 720. The management device 300 stores correlation information 750, which includes the associations between the user input, its corresponding event, and the corresponding event execution command.

Whether management device 300 directly receives the event execution command from control device 200 (such as when, for example, the management device 300 relays the command), or management device receives/monitors for events (such as when, for example, controllable device 100 sends a message 745 concerning the event).

In step 620, the management device 300 stores the correlation information.

Table 8 provides examples of events for different types of controllable devices.

TABLE 8
Examples of Events of Controllable Devices

| Electronic device to be | |
|---|---|
| controlled | Event |
| TV | Turn on/off, Volume up/down, Change channel |
| Refrigerator | Change temperature, Identify contents |
| Lamp | Turn on/off, Dimming |

The management device 300 may store the events of each registered controllable device, such as the information shown in Table 8.

Table 9 provides examples of user input for a watch-like control device.

TABLE 9
Examples of User Inputs for a Watch-like Control Device

| Control electronic device | User input |
|---|---|
| Watch-type electronic device | Tap gesture |
| | Upward flick gesture |
| | Downward flick gesture |

Table 10 provides examples of user inputs to a control device and their corresponding user inputs/actions when performed without the control device.

TABLE 10
Examples of User Inputs With/Without Control Device

| | User input detected by |
|---|---|
| User input of | management device |
| control electronic device | (when control device absent) |
| Tap gesture | Tap on wrist |
| Upward flick gesture | Upward sweep on wrist |
| Downward flick gesture | Downward sweep on wrist |

The management device may manage the relation between the user input of the control electronic device and the detected user input corresponding thereto, such as the relations illustrated in Table 10.

Table 11 provides examples of correlation information between user inputs and event execution commands, which are managed by the management device.

TABLE 11
Correlation Information between User Input and Event

| Executed event | User input |
|---|---|
| Turn on/off | Tap on wrist |
| Volume up | Upward sweep on wrist |
| Volume down | Downward sweep on wrist |

The management device 300 may store and manage the correlation information such as illustrated in Table 11 and, based on such correlation information, execute the event which corresponds to a detected user input.

While FIGS. 7A-7B show examples of how a management device may learn to associate user inputs to a control device with events/event execution commands, FIGS. 7C and 7D show examples of how a management device may control controllable devices in the absence of control device with correlation information gained by, for example, the learning method in FIG. 6.

As illustrated in FIG. 7C, a user performs user input 721 on, for example, the user's wrist or in the air, which corresponds to user input 720 for the control device 200. The management device 300 detects the generation of the user input 721. For example, if the management device 300 monitors the movement of the user using a camera module, management device 300 would capture one or more images as indicated by reference numeral 731. The management device 300 processes the acquired image(s) and detects the generation of the user input 721 on the basis of the image processing result.

The management device 300 determines the event execution command corresponding to the detected user input 721 using correlation information 750. In this example, the correlation information 750 includes information indicating that user input 721, comprising a gesture of moving a finger downward and then a touch, is associated with the turn-on event execution command. Based on the correlation information 750, the management device 300 identifies that the turn-on event execution command corresponds to the detected user input 721.

As illustrated in FIG. 7D, management device 300 transmits the identified turn-on event execution command 760 to the controllable device 100, in response to which controllable device 100 leaves turned-off state 740 and enters turned-on state 740. Accordingly, the user can control controllable device 100 by performing user input 721, which is similar to user input 720 on control device 200 when worn or held, even while not wearing or holding the control device 200.

FIGS. 8A to 8D are identical to FIGS. 7A to 7D, except where the user input in FIGS. 7A to 7D is a gesture and the user input in FIGS. 8A to 8D is a voice command. Thus, as with FIGS. 7A to 7D, FIGS. 8A-8B shows examples of how a management device may learn to associate user input (i.e., voice commands) to a control device with events/event execution commands according to the method in FIG. 6, while FIGS. 8C and 8D show examples of how a management device allows a user to use the same user input (i.e., voice commands) to control a controllable device when the control device is absent.

As discussed above, a management device acquires user input into a control device while the user is using it. In the example illustrated in FIG. 8A, a user speaks voice input 820 into the control device 200, where voice input 820 corresponds to the turn-on event for controllable device 100, which is presently in a turned-off state 810. As discussed in reference to FIG. 7A, the control device 200 may store a control application, in this case, a voice command application, to help identify and then transmit the turn-on event execution command corresponding to user input 820.

Meanwhile, and as with FIG. 7A, management device 300 records voice input 820 corresponding to the turn-on event. To do so, management device 300 may include a microphone module and/or an input/output interface that receives sound data from a microphone module. The management device 300 also detects that the turn-on voice input 820 is generated between time points t1 and t2. In some embodiments, the management device 300 may detect the turn-on event execution command is transmitted from the control electronic device 200 between time points t3 and t4. In such embodiments, the management device 300 determines that the recorded turn-on voice input 820 is associated with the turn-on event execution command when the difference between time points t2 and t3 is smaller than a preset threshold value. The management device 300 stores this association as correlation information.

As illustrated in FIG. 8B, after receiving the turn-on event execution command from control device 200, the controllable device 100 changes from turned-off state 810 into turned-on state 840. In embodiments where management device 300 does not directly detect/receive the turn-on event execution command when transmitted by control device 200, management device 300 may instead detect that controllable device 100 changed to the turned-on state 840 between time points t5 and t6. For example, the controllable device 100 may transmit message 845 reporting the change into the turned-on state 840 to the management device 300 between time points t5 and t6. Alternatively, the management device 300 may directly detect the execution of the event by recording that controllable device 100 enters the turned-on state 840 between time points t5 and t6. In embodiments where management device 300 does not directly detect/receive the turn-on event execution command when transmitted by control device 200, the management device 300 detects that voice input 820 is associated with the turn-on event and its corresponding turn-on event execution command and stores it, among other things, as correlation information 850.

FIGS. 8C and 8D show examples of how a management device allows a user to use the same user input (i.e., voice commands) to control a controllable device when the control device is absent.

As illustrated in FIG. 8C, the user performs user input 821, i.e., voice command 820, except in FIG. 8C the control device 200 is absent. The management device 300 detects and also records user input 821 using a microphone module that may be, for example, connected to or integrated into management device 300. The management device 300 determines the event execution command corresponds to the detected user input 821 on the basis of correlation information 850, which comprises, inter alia, information that voice input 820 is associated with the turn-on event and the turn-on event execution command. The management device 300 transmits the turn-on event execution command 860 to the controllable device 100. The controllable device 100 enters turned-on state 840 in response to the received turn-on event execution command 860. Therefore, the user can control controllable device 100 by performing similar user input 821 even while not wearing or holding the control device 200.

It may be easily understood by those of ordinary skill in the art that any kind of user input may be used in accordance with embodiments of the present disclosure, such as, for example, gaze/facial expression input.

FIG. 9 is a flowchart illustrating a learning method of a management device according to various embodiments of the present disclosure.

In step 910, management device 300 acquires multiple instances of user input for control device 200 over time. Management device 300 also stores information about correlations between the user inputs and any subsequent event execution command and/or event of controllable device 100.

In step 920, the management device 300 applies a learning algorithm to the acquired information. Depending on the embodiment, such application may be continuous, periodic, event-driven, device-initiated, etc. In step 930, the management device 300 uses the results from applying the learning algorithm to associate, e.g., specific event execution commands with user inputs (if such an association was justified based on the learning results). Accordingly, when a plurality of user inputs are similar but not exactly the same, the learning algorithm may still determine a correlation between the plurality of similar user inputs and, e.g., an event execution command for controllable device 100. Depending on the embodiment, the learning algorithm may use thresholds, such as a standard deviation, for differences between the user inputs in the plurality of similar user inputs to detect whether they are too different from each other to comprise a group of the same user input performed in multiple ways. By using a learning algorithm, the management device 300 can also adaptively change the correlation information if, for example, user inputs change over time.

In various embodiments of the present disclosure, the management device 300 may share the learning result with control device 200 and/or controllable device 100. In addition, the management device 300 may apply the learning result for a first user to a second user. In such an embodiment, the management device 300 may share the learning result in a group classified according to a particular criterion. Also, the management device 300 may also share the learning result with another management device.

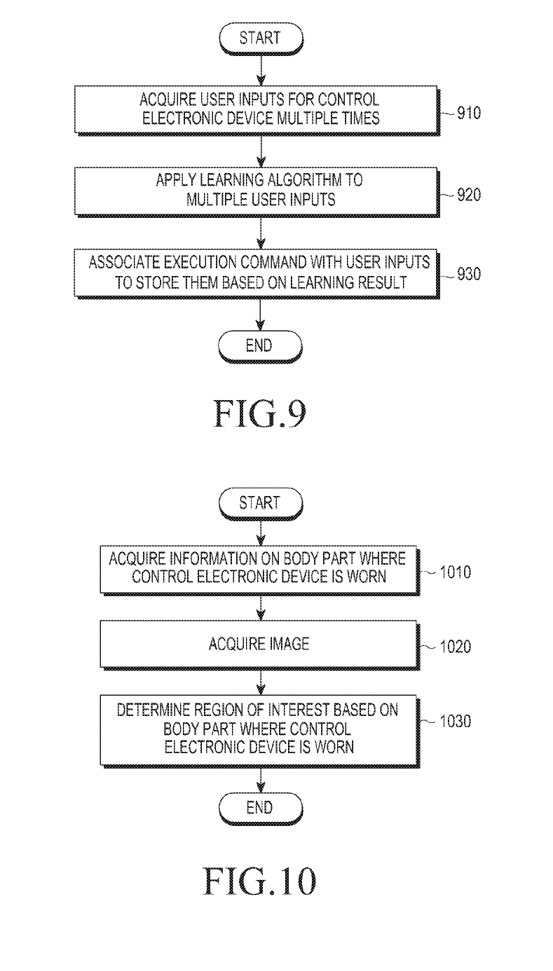

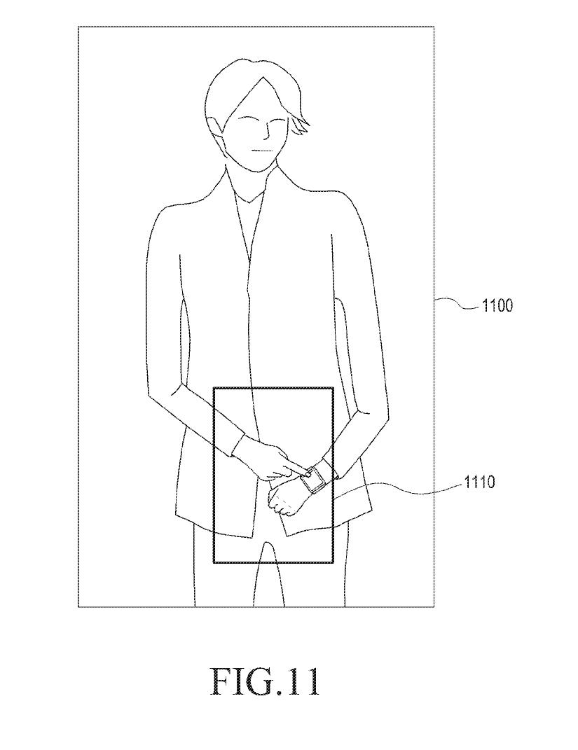

FIG. 10 is a flowchart illustrating a method of determining a region of interest according to various embodiments of the present disclosure. The embodiment of FIG. 10 will be described with reference to FIG. 11, which provides an example of a region of interest, according to various embodiments of the present disclosure.

Referring to FIG. 10, in step 1010, management device 300 acquires information on the body part on which control device 200 is worn. For example, the correlation information may include information that the control device 200 is worn on the wrist of a user, by which the management device 300 determines that the control device 200 is worn on the user's wrist.

In step 1020, the management device 300 acquires an image such as image 1100 illustrated in FIG. 11.

In step 1030, the management device 300 determines the region of interest within the acquired image on the basis of the body part on which control device 200 is worn. For example, in the embodiment illustrated in FIG. 11, the management device 300 uses the fact that the control device 200 is worn on the wrist to accordingly determine region of interest 1110, which includes the wrist.

The management device 300 may store information on a region of interest corresponding to the wrist in advance. For example, the management device 300 may be set in advance to determine a rectangle containing the fingertips and the elbow as a boundary to the region of interest. The management device 300 may also detect multiple regions corresponding to the fingertips and the elbow in the image and the determine the region of interest based on the detected regions. Once the region of interest is identified, management device 300 can process only the region of interest rather than the entire image, thereby considerably reducing the amount of calculation required for the image processing.

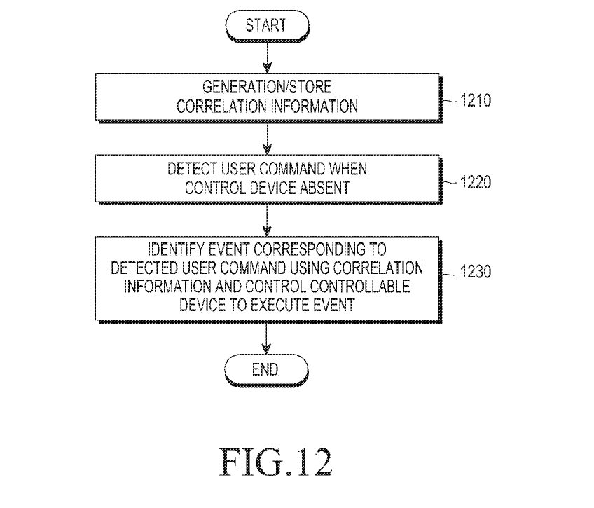

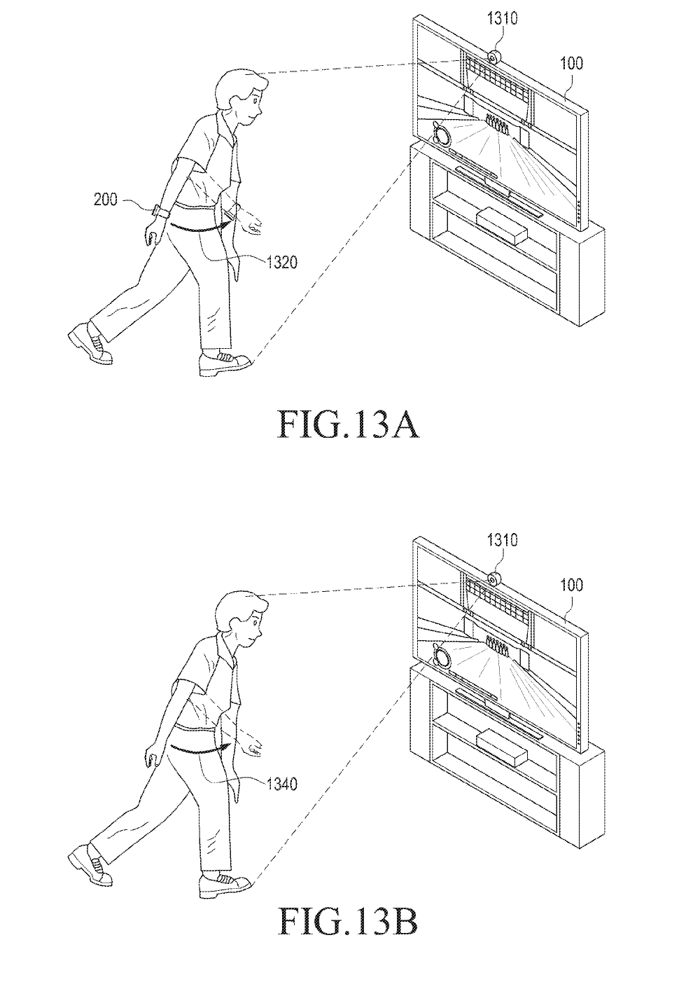

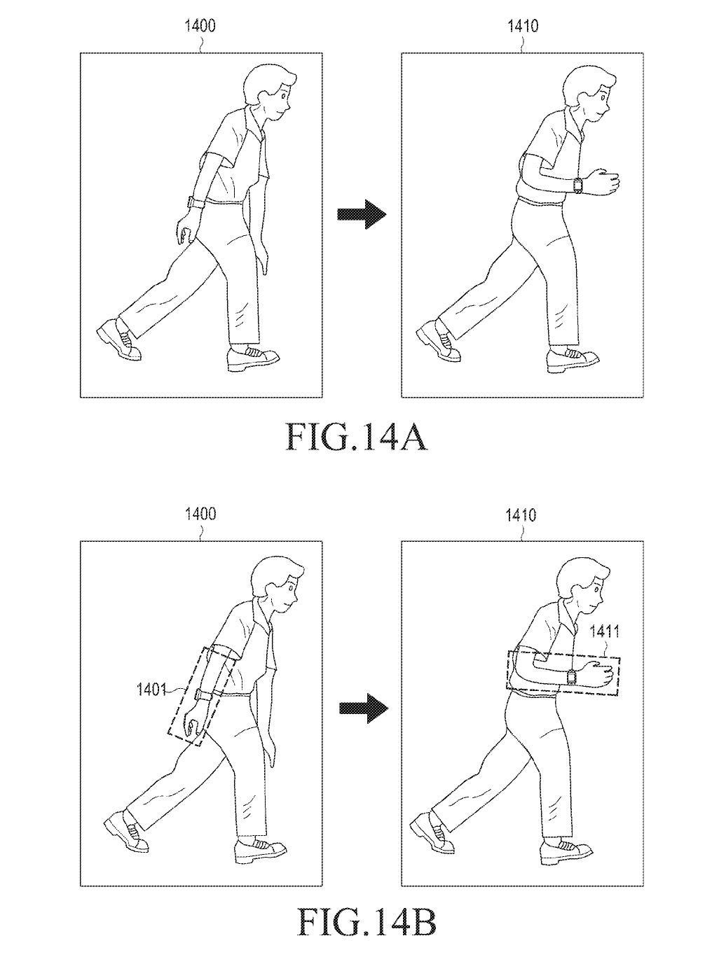

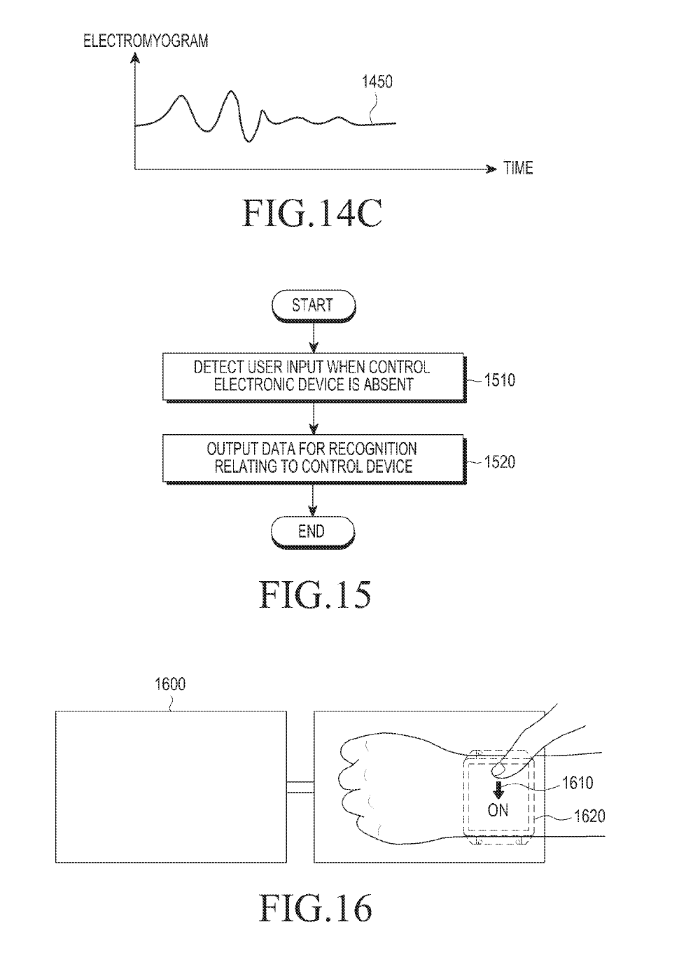

FIG. 12 is a flowchart illustrating a learning/control method of a management device according to various embodiments of the present disclosure. The embodiment of FIG. 12 will be described with reference to FIGS. 13A, 13B, and 14A to 14C. FIGS. 13A and 13B are examples of user input/commands using gestures with a control device and without a control device, respectively, according to various embodiments of the present disclosure. FIGS. 14A and 14B illustrate how a user input/command may be recognized from captured images according to various embodiments of the present disclosure. FIG. 14C illustrates an example of an electromyogram which may be used according to various embodiments of the present disclosure.

In step 1210, correlation information is generated (including, but not limited to, by learning, by user input, by data transfer from any of another management device, a controllable device, a control device, a network entity, etc.) and stored. For example, as illustrated in FIG. 13A, the management device 300 detects user input 1320 on the basis of captured image(s) from camera module 1310, associates user input 1320 with data, such as an electromyogram, from the control device 200 and then stores, inter alia, the association information as correlation information. In FIG. 13A, the control device is watch-like electronic device 200 which the user is wearing on his wrist. The user input 1320 comprises the user bending his right arm (on which the user is wearing the watch-like control device 200) by swinging his forearm forward. The management device 300 acquires a plurality of images over time, which show the initial body position 1400 and the final body position 1410 as illustrated in FIG. 14A. According to various embodiment, camera module 1310 may capture profile of the user as illustrated in FIGS. 14A and 14B.

Watch-like control device 200 includes a sensor module that can take an electromyogram of the muscles underlying the skin in contact with itself. Such electromyograms may be associated with the user's actual action, for example the bending of the right arm, with the event corresponding to such user input, and/or with the event execution command corresponding to the event in the correlation information. In various embodiments, the user input into watch-like control device 200 is stored in the correlation information as one or more electromyograms.

FIG. 14B shows an example of regions of interest according to various embodiments of the present disclosure. FIG. 14B shows the same body positions 1400 and 1410 illustrated in FIG. 14A, but with the same region of interest indicated by reference numeral 1401 in 1400 and reference numeral 1411 in 1410. In embodiments using regions of interest, the region of interest corresponding to user input 1320 (which comprises initial body position 1400 and final body position 1410) are identified and/or otherwise determined, and then stored with the correlation information. Later, the region of interest may be identified and isolated in captured image(s) so that only the region of interest is processed in each image. In the example of FIG. 14B, the region of interest is identified and isolated as shown by reference numeral 1401 in 1400, and identified and isolated as shown by reference numeral 1411 in 1410. Only regions of interests 1401 and 1411 are processed in images corresponding to 1400 and 1410, respectively.

FIG. 14C illustrates an example of an electromyogram 1450 which could be used as described herein according to various embodiments of the present disclosure.

As discussed above, step 1210 in FIG. 12, an example of which is illustrated in FIGS. 13A, 14A, and 14B, comprises the learning phase of a method according to various embodiments of the present disclosure. As discussed below, steps 1220 and 1230 of FIG. 12, an example of which is illustrated in FIG. 13B, comprise the control phase of a method according to various embodiments of the present disclosure—i.e., when the management device controls the controllable device in the absence of the control device.

In step 1220, the management device 300 detects the generation of a user command when the control device 200 is absent (in this case, watch-like device 200 is not being worn on the user's wrist). In the example illustrated in FIG. 13B, the user input/command 1340 comprises bending the right arm in a manner similar to user input/command 1320 in FIG. 13A, but while not wearing the control device 200.

In step 1230, the management device 300 identifies the event/event execution command corresponding to the detected user input on the basis of the correlation information and has controllable device 100 perform the corresponding event. In some embodiments, management device 300 may transmit data from the correlation information to the controllable device 100, and the controllable device 100 may use the received data as an event execution command and/or detected user input. For example, management device 300 may transmit one or more electromyograms corresponding to the detected user command/input 1340 (i.e., when the user bends his/her right arm while not wearing the control electronic device 200) which were stored as part of the correlation information, and the controllable device 100 may use the received electromyogram(s) as if received from the control device 200.

FIG. 15 is a flowchart illustrating a method of outputting data for recognition according to various embodiments of the present disclosure. The embodiment of FIG. 15 will be described in more detail with reference to FIG. 16. FIG. 16 shows an example of a glasses-type electronic device according to various embodiments of the present disclosure.

In step 1510, management device 300 detects the generation of user input while the control device 200 is absent from a network. As described above, the management device 300 stores correlation information between, for example, user input and event execution commands. In the example shown in FIG. 16, the user input 1610 comprises the gesture of moving a finger downward. In step 1520, the management device 300 may also output data for recognition relating to the control device 200 to a glasses-type electronic device 1600 while transferring an event execution command corresponding to the detected user input to the controllable device 100.

The management device 300 identifies turn-on event execution command and corresponding watch-like control device according to stored correlation information. The management device 300 transfers identified result to the glass-like device 1600. The glass-like device 1600 displays graphical data corresponding to the identified result. As illustrated in FIG. 16, the glass-like device 1600 displays graphical data 1620 indicating watch-like control device, i.e. identified result. The user may recognize graphical data 1620 and correctly input user input 1610 according to displayed graphical data 1620.

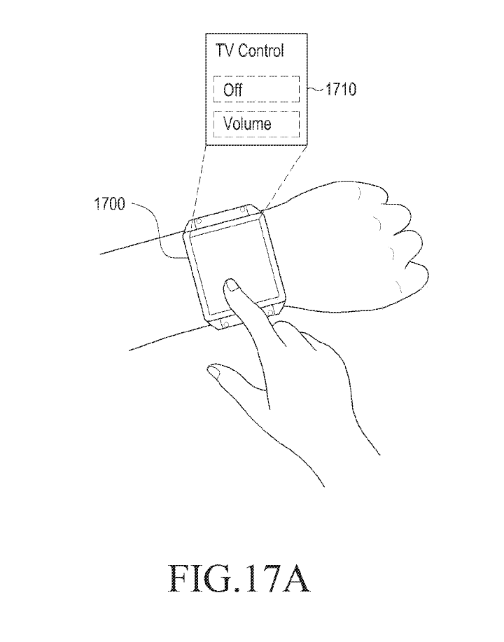

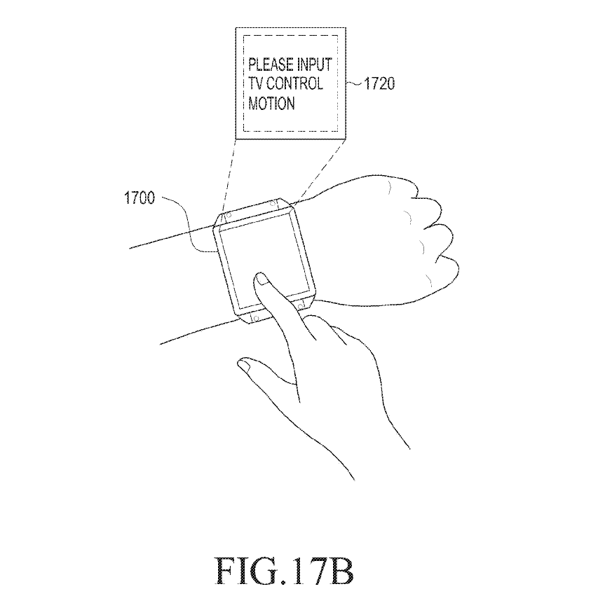

FIGS. 17A and 17B illustrate an example of data for recognition according to various embodiments of the present disclosure. In FIGS. 17A and 17B, a management device 300 transmits identification result according to correlation information to watch-like device 1700 and watch-like device 1700 displays data 1710 for recognition. In cases where a control device 200 is connected to a network, the management device 300 may receive, from the control device 200, all user interfaces provided by the control device 200 and transmits the same to watch-like device 1700. The watch-like device 1700 may display all kind of user interfaces. Meanwhile, in cases where the control device 200 is not connected to the network, the management device 300 may provide a user interface that is set as a default to watch-like device 1700 and watch-like device 1700 displays received user interface 1720.

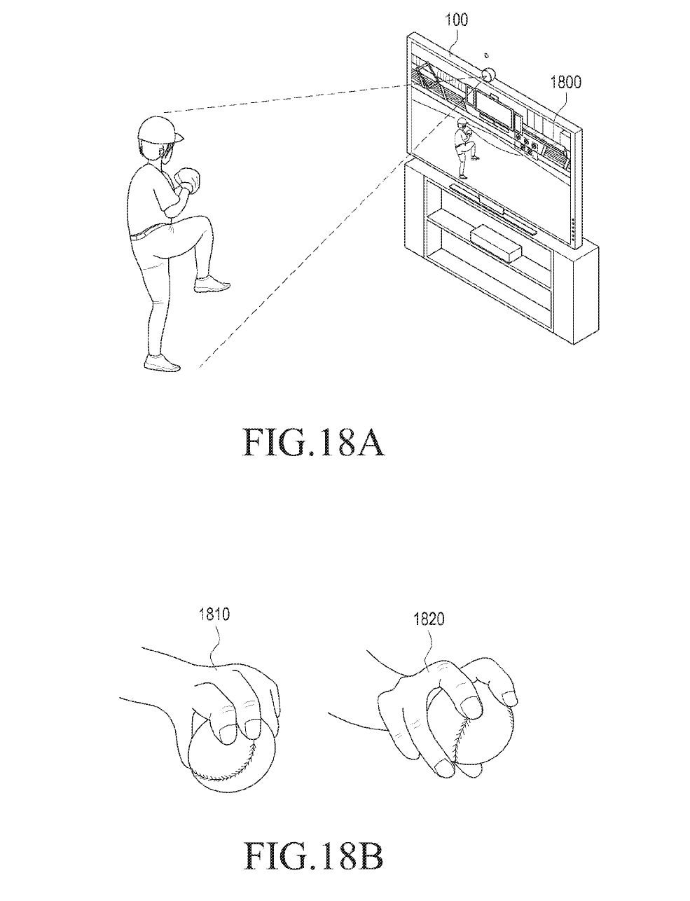

FIGS. 18A and 18B illustrate an example of identifying different user inputs according to various embodiments of the present disclosure.

As illustrated in FIG. 18A, controllable device 100 is a TV, and includes a camera module. In addition, in the embodiment of FIG. 18A, it is assumed that a management device 300 is implemented/included in controllable device 100. FIG. 18A shows a user performing a pitching motion.

Assuming the user is wearing an electromyogram sensing device while performing the pitch in FIG. 18A, the electromyogram sensing device senses the electromyogram of the user in his/her pitching motion and transmits the sensed electromyogram to controllable device 100. The controllable device 100 also acquires information on the movement of the user using images captured by its camera module. Controllable device 100 determines which pitch the user is performing in FIG. 18A using the received electromyogram and the user's movement information generated from images captured by its camera module. For example, as illustrated in FIG. 18B, the user's grip for a curve ball 1810 and a fast ball 1820 are different from each other, and thus their electromyograms would also be different from each other and may be used to help identify a pitch. In this embodiment, controllable device 100 stores correlation information which associates the user's movement information with the received electromyogram. In one embodiment, there may be a preset threshold value for the movement information and/or the electromyogram and controllable device 100 determines the type of pitch being made in FIG. 18A on the basis of the threshold value. There may be different threshold values for different users.

Assuming the user in FIG. 18A is not wearing a electromyogram sensing device, Controllable device 100 uses only images of the pitching motion to acquire movement information. The controllable device 100 to be controlled may acquire an electromyogram corresponding to the acquire movement information on the basis of the correlation information. The controllable device 100 may determine a pitch, e.g. curve or fast ball, using the electromyogram, acquired from the correlation information, together with the movement information.

According to various embodiments of the present disclosure, the management device may identify the movement corresponding to user input/command in more detail by determining a region of interest of a captured image. For example, the management device may determine the region of interest according to the type of running application. The controllable device 100 may determine a portion associated with the determination of a threshold value as the region of interest. For instance, the controllable device 100 may determine wrist of user as the region of interest when the controllable device 100 uses electromyogram for determining threshold value.

According to various embodiments of the present disclosure, a control method of a management device managing a network may include detecting the performance of a user input comprising a command for a controllable electronic device to execute an event while the user wears a control device, detecting the performance of similar user input while the user does not wear the control device, and controlling the controllable device to execute the event corresponding to the user input detected when the user was wearing the control device.

The components of any electronic device according to the present disclosure may be implemented by one or more components and the name of the corresponding component may vary depending on a type of the electronic device. In various embodiments, some of the elements described above may be omitted from an electronic device, or an electronic device may further include additional elements. Further, some of the components of an electronic device according to the various embodiments of the present disclosure may be combined to form a single entity, and thus, may equivalently execute functions of the multiple corresponding elements prior to the combination.

The term “module” as used herein may, for example, mean a unit including one of hardware, software, and firmware or a combination of two or more of them. The term “module” may be interchangeably used with, for example, the term “unit”, “logic”, “logical block”, “component”, or “circuit”. The “module” may be the smallest unit of an integrated component or a part thereof. The “module” may be the smallest unit that performs one or more functions or a part thereof. The “module” may be mechanically or electronically implemented. For example, a “module” according to the present disclosure may include at least one of an Application-Specific Integrated Circuit (ASIC) chip, a Field-Programmable Gate Array (FPGA), and any other programmable-logic device presently known or developed hereinafter.

According to various embodiments, at least some of the devices (for example, modules and/or functions thereof) or the method (for example, operations and/or steps) according to the present disclosure may be implemented by instructions/commands stored in a non-transitory computer-readable storage medium in a programming module form. When the instructions/commands are executed by one or more processors, the one or more processors execute a function(s) corresponding to the instructions/commands. The non-transitory computer-readable storage medium may be, for example, the memory 260.

The non-transitory computer readable recoding medium may include a hard disk, a floppy disk, magnetic media (e.g., a magnetic tape), optical media (e.g., a Compact Disc Read Only Memory (CD-ROM) and a Digital Versatile Disc (DVD)), magneto-optical media (e.g., a floptical disk), a hardware device (e.g., a Read Only Memory (ROM), a Random Access Memory (RAM), a flash memory), and the like. The instructions/commands/program may include high class language codes, which can be executed in a computer by using an interpreter, as well as machine codes made by a compiler. The aforementioned hardware device may be configured to operate as one or more software modules in order to perform the operation of the present disclosure, and vice versa.

A programming module according to the present disclosure may include one or more of the aforementioned components or may further include other additional components, or some of the aforementioned components may be omitted. Operations executed by a module, a programming module, or other component elements according to various embodiments of the present disclosure may be executed sequentially, in parallel, repeatedly, or in a heuristic manner. Further, some operations may be executed according to another order or may be omitted, or other operations may be added.

While the invention has been shown and described with reference to certain embodiments thereof, it will be understood by those skilled in the art that various changes in form and detail may be made therein without departing from the spirit and scope of the invention as defined by the appended claims.

What is claimed is:

1. A control method of a management device, comprising:
detecting a first user input; and
transferring a first event execution command corresponding to the first user input to a first electronic device on the basis of correlation information between an event execution command from a second electronic device and a user input,
wherein each event execution command is configured to make the first electronic device execute a corresponding event.

2. The control method of claim 1, further comprising:
acquiring the first user input for the second electronic device when the second electronic device exists in a network; and
storing the correlation information by associating the first user input, acquired when the second electronic device exists in the network, with the first event execution command.

3. The control method of claim 2, wherein acquiring the first user input for the second electronic device when the second electronic device exists in the network comprises:
acquiring user inputs multiple times when the second electronic device exists in the network and storing the correlation information on the basis of a learning result for the multiple acquired user inputs.

4. The control method of claim 3, further comprising:
applying the learning result to another user as well.

5. The control method of claim 2, wherein storing the correlation information comprises:
photographing the first user input for the second electronic device when the second electronic device exists in the network; and
storing the correlation information by associating first gesture information acquired by processing the photographed result with the first event execution command.

6. The control method of claim 5, wherein detecting the first user input comprises:
acquiring at least one image for a user of the network; and
when second gesture information acquired from the processing result of the at least one image corresponds to the first gesture information, determining that the first user input has been detected.

7. The control method of claim 6, wherein determining that the first user input has been detected comprises:
determining a preset body part on which the second electronic device is worn;
acquiring a region of interest (ROI) in the at least one image on the basis of the preset body part; and
when the second gesture information acquired from the processing result of the region of interest corresponds to the first gesture information, determining that the first user input has been detected.

8. The control method of claim 2, wherein storing the correlation information comprises:
recording a first voice for the second electronic device when the second electronic device exists in the network; and
storing the first voice.

9. The control method of claim 8, wherein detecting the first user input comprises:
acquiring a second voice from a user of the network; and
when the second voice corresponds to the first voice, determining that the first user input has been detected.

10. The control method of claim 1, further comprising:
storing the correlation information by associating the first user input with data from the second electronic device.

11. The control method of claim 10, further comprising:
controlling the first electronic device using the data from the second electronic device which is stored through the association.

12. The control method of claim 1, further comprising:
outputting data for recognition relating to the second electronic device.

13. The control method of claim 1, further comprising:
converting an event execution command in the second electronic device into an event execution command in the first electronic device to transfer the converted event execution command to the first electronic device.

14. A management device, comprising:
a storage module that stores correlation information between an event execution command from a second device and a user input; and
a processor that detects a first user input and transfers a first event execution command corresponding to the first user input to a first electronic device on the basis of the correlation information,
wherein each event execution command is configured to make the first electronic device execute a corresponding event.

15. The management device of claim 14, wherein the processor acquires the first user input for the second electronic device when the second electronic device exists in a network, and associates the first user input, acquired when the second electronic device exists in the network, with the first event execution command to store the correlation information in the storage module.

16. The management device of claim 15, wherein the processor acquires user inputs multiple times when the second electronic device exists in the network and stores the correlation information on the basis of a learning result for the multiple acquired user inputs.

17. The management device of claim 16, wherein the processor applies the learning result to another user as well.

18. The management device of claim 15, further comprising:
a camera module that photographs a user input for the second electronic device when the second electronic device exists in the network,
wherein the processor associates first gesture information acquired by processing the photographed result with the first event execution command to store the correlation information in the storage module.

19. The management device of claim 18, wherein the processor acquires at least one image for a user of the network and, when second gesture information acquired from the processing result of the at least one image corresponds to the first gesture information, determines that the first user input has been detected.

20. A method of controlling a first electronic device, comprising:
detecting a first user input; and
controlling the first electronic device using first data corresponding to the first user input on the basis of correlation information between data received from a second electronic device and a user input entered into the second electronic device.
